(19) United States
(12) Patent Application Publication
(10) Pub. No.: US 2023/0291984 A1
(43) Pub. Date: Sep. 14, 2023

(54) METHODS AND APPARATUSES FOR INSTALLING AN AUTOMATIC MOUNTING ASSEMBLY

(71) Applicant: Johnson Controls Tyco IP Holdings LLP, Milwaukee, WI (US)

(72) Inventor: Aditya Kiran CHANDWADKAR, Nashik Maharahtra (IN)

(21) Appl. No.: 17/694,279

(22) Filed: Mar. 14, 2022

(51) Int. Cl. H04N 5/225; G08B 13/196

(52) U.S. Cl. CPC H04N 5/2253; G08B 13/1966; G08B 13/19632

(57) ABSTRACT

Aspects of the present disclosure include an automatic mounting assembly, comprising: a camera, a bracket including at least one motorized wheel, wherein the bracket is configured to moveably mount to a post for positioning the camera, and a controller device including: a motor configured to drive the at least one motorized wheel to move the automatic mounting assembly along the post, and a communication circuit configured to receive a control signal for operating the motor.

### BACKGROUND

Surveillance cameras may be deployed both indoor and outdoor. In order to improve the visual coverage of the surveillance cameras, it may be desirable to install the surveillance cameras in elevated locations (e.g., on top of light posts). However, such installation may require the installer to climb a ladder or other similar tools, which may be inconvenient and/or dangerous to the installer. Therefore, improvements may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include an automatic mounting assembly, comprising: a camera, a bracket including at least one motorized wheel, wherein the bracket is configured to moveably mount to a post for positioning the camera, and a controller device including: a motor configured to drive the at least one motorized wheel to move the automatic mounting assembly along the post, and a communication circuit configured to receive a control signal for operating the motor.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for utilizing an automatic mounting assembly in accordance with aspects of the present disclosure;

FIG. 2 illustrates an example of a bracket in accordance with aspects of the present disclosure; and

FIG. 3 illustrates an example of a computer system in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

In some aspects of the present disclosure, an automatic mounting assembly may be utilized by an installer of a surveillance camera to install a surveillance camera beyond the reach of the installer without using ladders or other similar tools. The installer may remotely control the automatic mounting assembly to ascend along a pole or a post. Once reaching the desired height, the installer may activate the surveillance camera for normal operations. In certain aspects of the present disclosure, the surveillance camera may be powered by batteries, electrical connections, and/or solar panels.

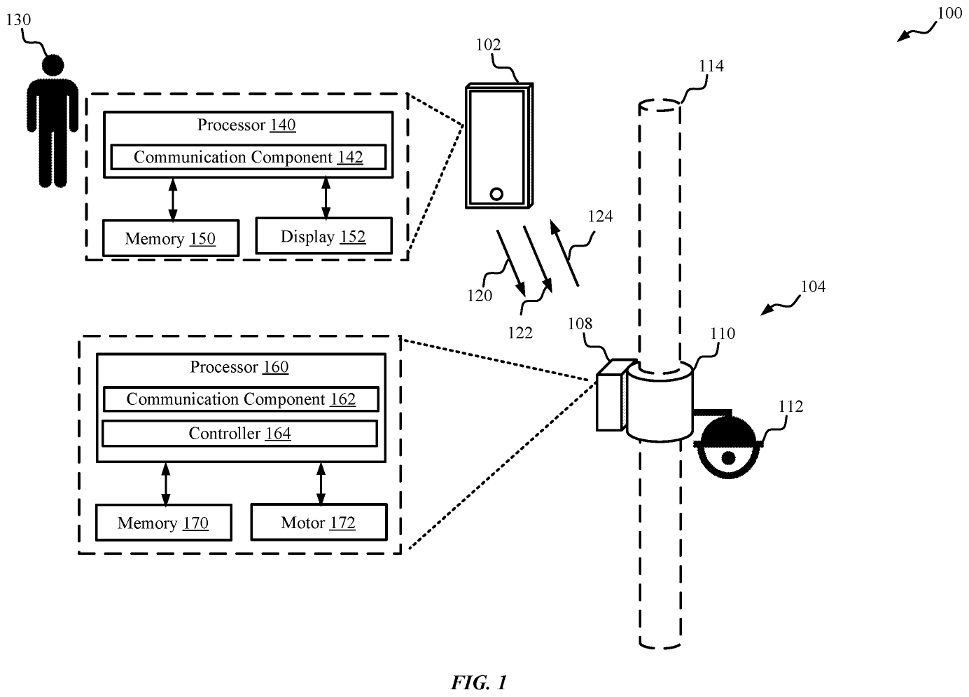

Referring to FIG. 1, in a non-limiting implementation, an example of an environment 100 for utilizing an automatic mounting assembly is shown according to aspects of the present disclosure. The environment 100 may include a mobile device 102. The environment 100 may include an automatic mounting assembly 104. The mobile device 102 may be configured to control the automatic mounting assembly 104. The automatic mounting assembly 104 may include a controller device 108, a bracket 110, and a camera 112. The automatic mounting assembly 104 may be configured to ascend and/or descend a post 114 based on control signals received by the controller device 108 from the mobile device 102.

Still referring to FIG. 1, in an aspect of the present disclosure, the mobile device 102 may include a processor 140 that executes instructions stored in a memory 150 for performing the functions described herein. The mobile device 102 may include the memory 150. The memory 150 may include software instructions and/or hardware instructions.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, controllers, digital signal processors (DSPs), field programmable gate arrays (FPGAs), programmable logic devices (PLDs), state machines, gated logic, discrete hardware circuits, and other suitable hardware configured to perform the various functionality described herein. The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

In certain aspects, the processor 140 may include a communication component 142 configured to communicate with external devices via one or more wired and/or wireless connections. The communication component 142 may be implemented hardware (e.g., application specific integrated circuit, application processors, field programmable gate arrays, etc.), software (e.g., instructions stored in the memory 150 and executed by the processor 140), or a combination thereof.

In certain aspects, the mobile device 102 may include a display 152 configured to display images captured by the camera 112 of the automatic mounting assembly 104. The display 152 may be a touchscreen, a liquid crystal display, an organic light emitting diode display, a micro electromechanical system (MEMS) display, and/or one or more other suitable displays.

In one aspect of the current disclosure, the controller device 108 may include a processor 160 and a memory 170. The processor 160 may be configured to execute instructions stored in the memory 170 to perform aspects of the present disclosure. The processor 160 may include a communication component 162 configured to communicate with external devices via one or more wired and/or wireless connections. The processor 160 may include a controller 164 configured to control a motor 172 and/or the bracket 110 (as described below). The controller device 108 may include a motor 172 configured to drive one or more motorized wheels in the bracket 110.

In an aspect of the present disclosure, the camera 112 may be a pan-tilt-zoom (PZT) camera.

In one aspect of the present disclosure, the automatic mounting assembly 104 may include one or more disposable batteries, one or more rechargeable batteries, one or more solar panels, and/or other mechanisms (not shown) for providing electrical energy to the automatic mounting assembly 104.

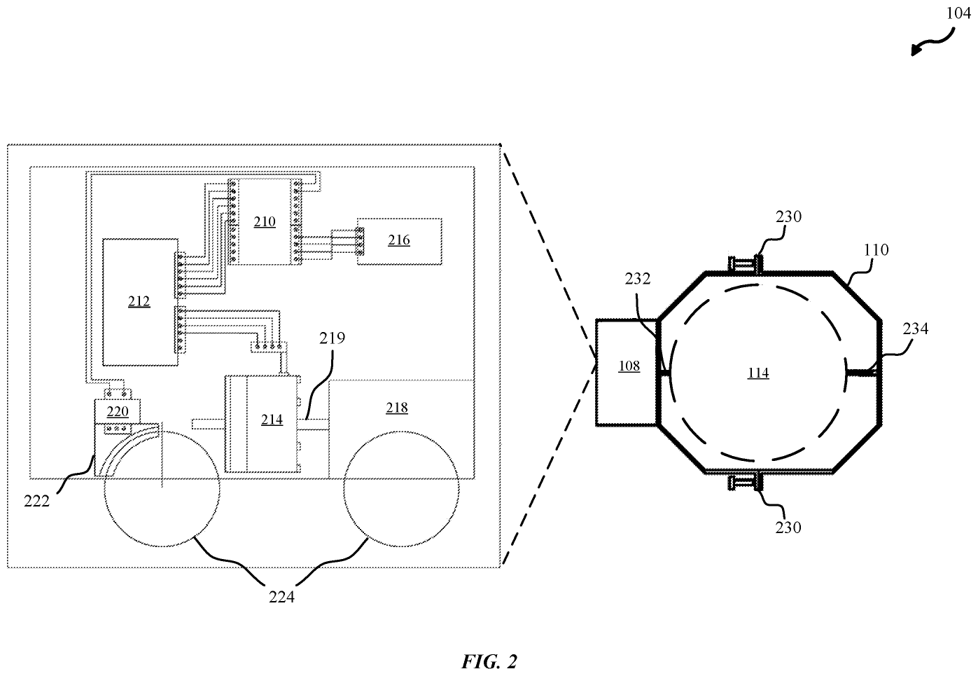

During operation, an installer 130 of the automatic mounting assembly 104 may moveably fasten the bracket 110 of the automatic mounting assembly 104 around the post 114 at an elevation reachable by the installer 130 without utilizing any ladders or similar tools. The bracket 110 may include one or more fasteners such as a screw, an allen key, a bolt, a tie, a clamp, a clasp, a clip, a hook, a nail, a pin, or any suitable fasteners. The one or more fasteners may provide means for fastening the bracket 110 to the post 114. The mobile device 102 may transmit a control signal 120 to the controller device 108. The controller device 108 may receive the control signal 120. In response to receiving the control signal 120, the controller 164 may operate the motor 172 to drive one or more motorized wheels (see e.g., FIG. 2) in the bracket 110 to cause the automatic mounting assembly 104 to ascend the post 114. In some instances, the control signal 120 may indicate a desired height for the bracket 110 to ascend. In other instances, the control signal 120 may be continuously sent to the controller device 108 to cause the ascent of the automatic mounting assembly 104.

After reaching a desired height, the automatic mounting assembly 104 may terminate the ascent. This may be caused by the termination of the control signal 120 transmitted by the mobile device 102, or after the automatic mounting assembly 104 has reached a predetermined height as indicated by the control signal 120. The mobile device 102 may transmit an activation signal 122 to activate the camera 112. The camera 112 may begin capturing image data, video data, and/or audio data. In some aspects of the present disclosure, the camera 112 may transmit captured data 124 to the mobile device 102. The captured data 124 may include image data, video data, and/or audio data. The camera 112 may optionally include a speaker for playing audio data. Alternative or additionally, the camera 112 may transmit the captured data 124 to a data center, a cloud storage, a surveillance center, or other destinations.

In certain aspects of the present disclosure, the mobile device 102 may display at least a portion of the captured data 124 via the display 152. The installer 130 may view the at least portion of the captured data 124 and optionally adjust one or more of the height of the automatic mounting assembly 104, the zoom of the camera 112, the viewing angle of the camera 112, the tilt of the camera 112, the panning of the camera 112, and/or other relevant parameters associated with the automatic mounting assembly 104.

In certain optional aspects, the mobile device 102 may transmit the control signal 120 to the controller device 108 to lower the automatic mounting assembly 104 for the installer 130 to repair, upgrade, and/or maintain the automatic mounting assembly 104. For example, the installer 130 may repair damaged wires and/or wheels (not shown), replace batteries (not shown), clean the camera 112, and/or perform other tasks.

Turning to FIG. 2, an example of the automatic mounting assembly 104 is shown. In certain aspects of the present disclosure, the bracket 110 may include one or more fasteners 230 configured to removably fasten the bracket 110 to the post 114. The one or more fasteners 230 may be a screw, an Allen key, a bolt, a tie, a clamp, a clasp, a clip, a hook, a nail, a pin, or any suitable fasteners. The bracket 110 may include one or more motorized wheels 232. Additionally, the bracket 110 may further include one or more passive wheels 234.

In some aspects, the controller device 108 may include a controller chip 210 configured to control the operations of the controller device 108 as explained above. The controller device 108 may include a stepper motor driver 212 configured to control the operations of a stepper motor 214. The controller device 108 may include a stepper motor 214 configured to drive a gear box 218 via a shaft 219. The stepper motor 214 may be configured to drive one or more wheel rotors 224, which in turn drive the one or more motorized wheels 232. The controller device 108 may include a latch lock 222 configured to lock at least one of the one or more wheel rotors 224 and/or the one or more motorized wheels 232. The controller chip 210 may be configured to control the latch lock 222 via a relay module 220.

In some aspects of the present disclosure, the controller device 108 and/or the components of the controller device 108 may receive electrical energy from one or more of solar panels, batteries, or other suitable devices for providing electrical energy.

In certain aspects, the controller device 108 may include a communication module 216 for communicating with the mobile device 102 and/or other external devices. The communication module 216 may include one or more of a Bluetooth module, a Wireless Fidelity (Wi-Fi) module, a Near Field Communication (NFC) module, or any other suitable wired or wireless communication modules.

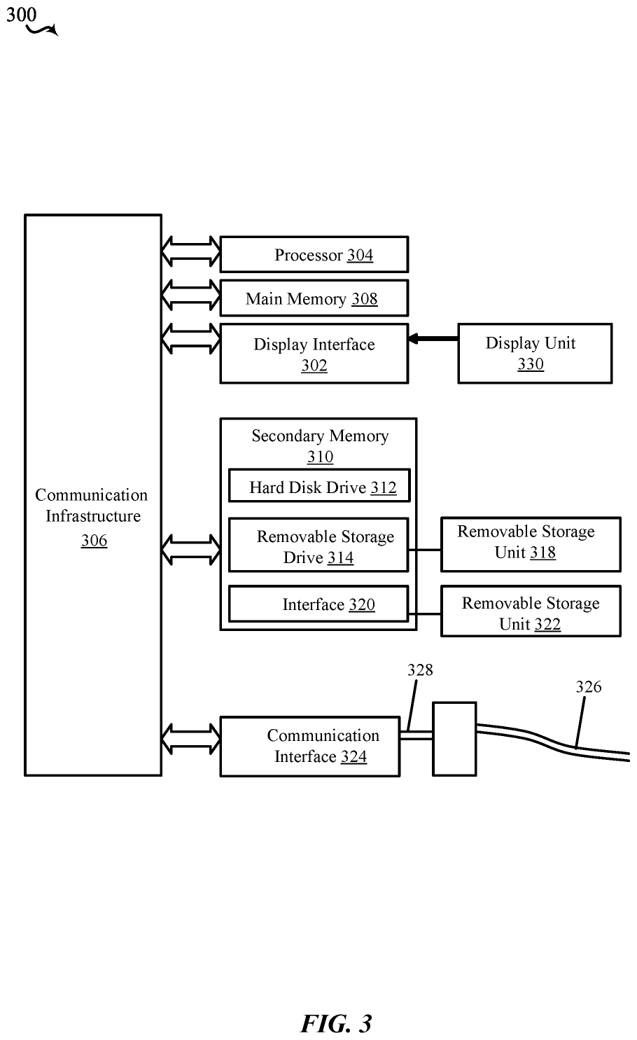

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 300 is shown in FIG. 3. In some examples, the mobile device 102, the controller device 108, and/or the camera 112 may be implemented as the computer system 300 shown in FIG. 3. The mobile device 102, the controller device 108, and/or the camera 112 may include some or all of the components of the computer system 300.

The computer system 300 includes one or more processors, such as processor 304. The processor 304 is connected with a communication infrastructure 306 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 300 may include a display interface 302 that forwards graphics, text, and other data from the communication infrastructure 306 (or from a frame buffer not shown) for display on a display unit 330. Computer system 300 also includes a main memory 308, preferably random access memory (RAM), and may also include a secondary memory 310. The secondary memory 310 may include, for example, a hard disk drive 312, and/or a removable storage drive 314, representing a floppy disk drive, a magnetic tape drive, an optical disk drive, a universal serial bus (USB) flash drive, etc. The removable storage drive 314 reads from and/or writes to a removable storage unit 318 in a well-known manner. Removable storage unit 318 represents a floppy disk, magnetic tape, optical disk, USB flash drive etc., which is read by and written to removable storage drive 314. As will be appreciated, the removable storage unit 318 includes a computer usable storage medium having stored therein computer software and/or data. In some examples, one or more of the main memory 308, the secondary memory 310, the removable storage unit 318, and/or the removable storage unit 322 may be a non-transitory memory.

Alternative aspects of the present disclosures may include secondary memory 310 and may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and the removable storage unit 322 and the interface 320, which allow software and data to be transferred from the removable storage unit 322 to computer system 300.

Computer system 300 may also include a communications circuit 324. The communications circuit 324 may allow software and data to be transferred between computer system 300 and external devices. Examples of the communications circuit 324 may include a modem, a network interface (such as an Ethernet card), a communications port, a Personal Computer Memory Card International Association (PCMCIA) slot and card, etc. Software and data transferred via the communications circuit 324 are in the form of signals 328, which may be electronic, electromagnetic, optical or other signals capable of being received by the communications circuit 324. These signals 328 are provided to the communications circuit 324 via a communications path (e.g., channel) 326. This path 326 carries signals 328 and may be implemented using wire or cable, fiber optics, a telephone line, a cellular link, an RF link and/or other communications channels. In this document, the terms “computer program medium” and “computer usable medium” are used to refer generally to media such as the removable storage unit 318, a hard disk installed in hard disk drive 312, and signals 328. These computer program products provide software to the computer system 300. Aspects of the present disclosures are directed to such computer program products.

Computer programs (also referred to as computer control logic) are stored in main memory 308 and/or secondary memory 310. Computer programs may also be received via communications circuit 324. Such computer programs, when executed, enable the computer system 300 to perform the features in accordance with aspects of the present disclosures, as discussed herein. In particular, the computer programs, when executed, enable the processor 304 to perform the features in accordance with aspects of the present disclosures. Accordingly, such computer programs represent controllers of the computer system 300.

In an aspect of the present disclosures where the method is implemented using software, the software may be stored in a computer program product and loaded into computer system 300 using removable storage drive 314, hard disk drive 312, or the interface 320. The control logic (software), when executed by the processor 304, causes the processor 304 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. An automatic mounting assembly, comprising:
a camera;
a bracket including at least one motorized wheel, wherein the bracket is configured to wrap around a post and moveably mount to the post for positioning the camera; and
a controller device including:
a motor configured to drive the at least one motorized wheel to move the automatic mounting assembly along the post; and
a communication circuit configured to receive a control signal for operating the motor.

2. The automatic mounting assembly of claim 1, further comprising at least one of one or more solar panels, one or more rechargeable batteries, or one or more disposable batteries to supply electrical energy to the automatic mounting assembly.

3. The automatic mounting assembly of claim 1, wherein the camera comprises:
an image capturing device configured to capture pictures or videos; and
a camera communication circuit configured to transmit the captured pictures or videos.

4. The automatic mounting assembly of claim 1, wherein the camera comprises a pan-tilt-zoom (PZT) camera.

5. The automatic mounting assembly of claim 1, wherein the motor is a stepper motor.

6. The automatic mounting assembly of claim 1, wherein the bracket further comprises one or more fasteners configured to removably fasten the bracket to the post.

7. The automatic mounting assembly of claim 6, wherein the one or more fasteners includes a screw, an allen key, a bolt, a tie, a clamp, a clasp, a clip, a hook, a nail, or a pin.

8. The automatic mounting assembly of claim 1, wherein the controller device includes at least one of a Bluetooth module, a Wireless Fidelity (Wi-Fi) module, or a Near Field Communication (NFC) module.

9. The automatic mounting assembly of claim 1, further comprising a latch lock configured to lock the at least one motorized wheel.

10. The automatic mounting assembly of claim 1, further comprising a shaft and a gear box, wherein the motor is further configured to drive the at least one motorized wheel via the shaft and the gear box.

11. An automatic mounting assembly system, comprising:
an automatic mounting assembly, comprising:
a camera;
a bracket including at least one motorized wheel, wherein the bracket is configured to wrap around a post and moveably mount to the post for positioning the camera; and
a controller device including:
a motor configured to drive the at least one motorized wheel to move the automatic mounting assembly along the post; and
a communication circuit configured to receive a control signal for operating the motor; and
a mobile device configured to transmit the control signal for operating the motor.

12. The automatic mounting assembly system of claim 11, wherein the automatic mounting assembly further comprises at least one of one or more solar panels, one or more rechargeable batteries, or one or more disposable batteries to supply electrical energy to the automatic mounting assembly.

13. The automatic mounting assembly system of claim 11, wherein the camera comprises:
an image capturing device configured to capture pictures or videos; and
a camera communication circuit configured to transmit the captured pictures or videos to the mobile device.

14. The automatic mounting assembly system of claim 13, wherein the mobile device is configured to display the captured pictures or videos via a display.

15. The automatic mounting assembly system of claim 13, wherein the mobile device is configured to provide sound associated with the captured videos via a speaker.

16. The automatic mounting assembly system of claim 11, wherein the bracket further comprises one or more fasteners configured to removably fasten the bracket to the post.

17. The automatic mounting assembly system of claim 16, wherein the one or more fasteners includes a screw, an Allen key, a bolt, a tie, a clamp, a clasp, a clip, a hook, a nail, or a pin.

18. The automatic mounting assembly system of claim 11, wherein the controller device includes at least one of a Bluetooth module, a Wireless Fidelity (Wi-Fi) module, or a Near Field Communication (NFC) module.

19. The automatic mounting assembly system of claim 11, wherein the automatic mounting assembly further comprises a latch lock configured to lock the at least one motorized wheel.

20. The automatic mounting assembly system of claim 11, wherein the automatic mounting assembly further comprises a shaft and a gear box, wherein the motor is further configured to drive the at least one motorized wheel via the shaft and the gear box.
